(19) United States
(12) Patent Application Publication
(10) Pub. No.: US 2016/0018901 A1
(43) Pub. Date: Jan. 21, 2016

(54) ENABLING DATA TRACKING WITHOUT REQUIRING DIRECT CONTACT

(71) Applicant: Richard D. Woolley, Orem, UT (US)

(72) Inventor: Richard D. Woolley, Orem, UT (US)

(21) Appl. No.: 14/804,295

(22) Filed: Jul. 20, 2015

Related U.S. Application Data
(60) Provisional application No. 62/026,396, filed on Jul. 18, 2014.

(51) Int. Cl. G06F 3/01; G06F 1/16

(52) U.S. Cl. CPC G06F 3/017; G06F 3/011; G06F 1/163

(57) ABSTRACT

A system and method for activating and deactivating a device that is capable of performing monitoring functions such as the recording of physical parameters such as heart rate, time exercised, or capable of recording using a video camera, and may be referred to as a Tracker, wherein the system and method enables a user to quickly activate or deactivate a function by simple movement of a signaling device near the Tracker, wherein the Tracker may be toggled on and off whenever the signaling device is moved adjacent to the Tracker, and wherein toggling may be indicated by an audible, visual and/or haptic indicator.

### BACKGROUND

### Description of Related Art

In today's fitness and active world, there are many apps and devices that may enable the tracking and recording of types of data. For example, there are wearable devices that may be used for the tracking or recording of data parameters including but not limited to speed, elevation, calories burned, minutes exercised, steps taken and heart rate. These wearable devices may also be used to record video and/or audio. These wearable devices will be referred to as a “Tracker” throughout this document.

Common methods of controlling a Tracker may include physically touching the Tracker to start, stop, pause or perform some other function. However, it is not always convenient to touch the Tracker. For example, there are many activities that occur in environments where the user may be wearing gloves that make tactile control difficult or impossible, or the environment itself may make it difficult. The environment may be around water, snow or ice, or the environment may be cold, hot, and dusty or have some other condition that makes it difficult for tactile control to occur.

Another condition that may make tactile control difficult is that the user may be moving and it may be difficult or dangerous to use a hand to control the Tracker. For example, the user may be skiing, running, cycling, boating or participating in some other activity where the user cannot easily make the fine movements necessary for the tapping of a small button or other tactile control. Runners may have to stop swinging their arms, skiers may have to stop using ski poles, cyclists may have to release a grip on a handlebar for a long period of time, etc.

### BRIEF SUMMARY

The present invention is a system and method for activating and deactivating a device that is capable of performing monitoring functions such as the recording of physical parameters such as heart rate time exercised, or capable of recording using a video camera, and may be referred to as a Tracker, wherein the system and method enables a user to quickly activate or deactivate a function by simple movement of a signaling device near the Tracker, wherein the Tracker may be toggled on and off whenever the signaling device is moved adjacent to the Tracker, and wherein toggling may be indicated by an audible, visual and/or haptic indicator.

In a first embodiment, the system and method includes a signaling device and a separate monitoring or recording device that is activated and deactivated using at least one non-contact gesture.

In a second embodiment, the system and method includes a signaling device, an intermediate device such as a smart phone or cell phone, and a monitoring and recording device, wherein the signaling device and the monitoring or recording device both communicate with each other through the intermediate device.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective illustration showing a glove, an Activator in the glove, and a Tracker which is coupled to a video camera.

FIG. 2 is a perspective illustration showing a glove, an Activator in the glove, and a Tracker which is coupled to a video camera.

### DETAILED DESCRIPTION

Reference will now be made to the drawings in which the various embodiments of the present invention will be given numerical designations and in which the embodiments will be discussed so as to enable one skilled in the art to make and use the invention. It is to be understood that the following description illustrates embodiments of the present invention, and should not be viewed as narrowing the claims which follow.

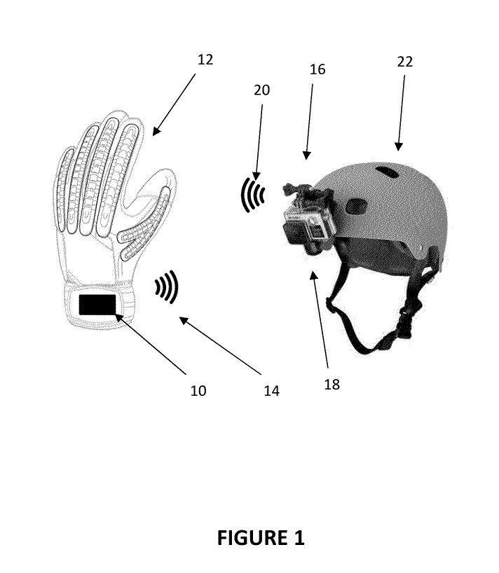

FIG. 1 is an illustration of a first embodiment of the present disclosure and is directed to a system and method for activating and deactivating a device that is capable of performing recording or monitoring functions. In the first embodiment, the system includes a signaling device or Activator 10. The Activator 10 may be disposed within or attached to another object such as a glove 12. In the embodiment shown in FIG. 1, the Activator 10 is disposed within the glove 12 because the activity is taking place while wearing the glove. However, it should be understood that the glove 12 is not a limitation of the first embodiment, but is only an example of an article of clothing or other object which also includes the Activator 10 attached to or embedded within the object.

In an alternative embodiment, the Activator may include straps or other means of attachment that enable the Activator to be attached directly to a body part. For example, the Activator may be worn similar to a watch and include straps to go around a wrist. Alternatively, the Activator may be coupled to or embedded within a prosthesis.

The Activator 10 may be capable of sending and/or receiving a signal 14 as needed. Accordingly, the Activator 10 may or may not include a power source, but may include an antenna for sending and/or receiving a signal. The Activator 10 may include the ability to provide an indication that a signal has been sent or received. The indication from the Activator 10 may be audio, visual, haptic or a combination of these methods.

In a manner similar to the Activator 10, a Tracker 16 (or tracking device) may also be an integral part of a recording or monitoring device, or it may be an add-on component and include some means of being attached to or embedded within the recording or monitoring device. In the embodiment shown in FIG. 1, the Tracker 16 is shown as part of a video camera 18, and it may be embedded or attached to it. Thus, the Tracker may generally be referred to as the combination of the recording or monitoring device and a device for receiving a signal and turning the receiving or monitoring device on and off. In this embodiment the Tracker 16 is attached to a helmet 22.

What is important is that the Tracker 16 include the ability to turn on and off the recording or monitoring function. This ability may be implemented in many different ways. For example, the Tracker may be a switch that activates and deactivates the recording or monitoring function.

The first embodiment illustrates the concept of the Activator 10 in the glove 12 being used to transmit a signal to the Tracker 16 to toggle it on or off so that the video starts or stops recording. Any suitable non-contact gesture may be used to cause the video camera 18 to start or stop recording. In other words, if the Tracker 16 is in an activated state, toggling the Tracker with the Activator 10 will cause the Tracker to change to a different state. In this case, the Tracker 16 will change to a deactivated state. Likewise, toggling the Tracker 16 again will cause the Tracker 16 to change to an activated state. Thus, performing a non-contact gesture with the Activator 10 will change the state of the Tracker 16.

For example, the user may simply bring the glove 12 and the attached Activator 10 within a predefined distance of the Tracker 16 and the video camera 18. However, it should be understood that the user is bringing the Activator 10 within a predefined distance of the Tracker 16, and the glove 12 and the video camera 18 are not objects that are part of the non-contact gesture.

The Activator 10 and the Tracker 16 may use any appropriate transmission technology for sending a signal from the Activator to the Tracker. For example, the Activator 10 and the Tracker 16 may use transmission technology selected from the group of transmission technologies consisting of radio frequency technology, electric field technology or magnetic field technology.

In an example of radio frequency technology, the Activator 10 and the Tracker 16 may use near field communication (NFC) technology, Bluetooth™ technology, WiFi, cell phone wireless communication or any other RF technology that enables a signal to be transmitted from the Activator to the Tracker 16.

Alternatively, the Activator 10 and the Tracker 16 may use a magnetic field or capacitive proximity technology to transmit a signal.

All embodiments of the present invention may use a high power, a low power or a no-power system for transmitting the signal from the Activator 10 to the Tracker 16. Thus, the Activator 10 and the Tracker 16 may use passive technology, active technology or a combination of passive and active technology. For example, the Activator 16 may include technology to generate a strong electromagnetic field that powers the Activator 10, much like a contactless card reader may provide power to a contactless smart card in a manner that is known to those skilled in the art. Another example may be an NFC tag that is not powered but it powered by the Tracker 16.

The first embodiment shows the Activator 10 may be disposed at a convenient location on a user. However, the user may dispose the Activator 10 in any location that enables a user to bring it close to the Tracker 16. Accordingly, in an alternative embodiment, either the Activator 10 or the Tracker 16 may be disposed in a location that is not on the body of the user but it instead on an object that is being used. For example, the Activator 10 or the Tracker 16 might be disposed on a handlebar, on a ski pole or on or in any equipment that is being used. The user would then bring the Activator 10 to the Tracker 16, or the Tracker to the Activator.

It is understood that the method of operation of the invention includes bringing the Activator 10 and the Tracker in close enough proximity to each other to enable the toggling of a function on the Tracker. However, in order to avoid accidental triggering of the Tracker 16 by the Activator 10, it may be necessary to add one or more requirements to this gesture.

Accordingly, in an alternative embodiment, the Activator 10 may need to be more than just moved to perform a particular gesture. For example, the Activator 10 may need to move in a certain direction relative to the Tracker. For example, the Activator 10 may need to approach the Tracker 16 from a certain direction in order to be perceived as an activating or deactivating gesture.

Another non-contact gesture may be multiple movements towards and away from the Tracker 16 with the Activator 10. For example, a single movement towards and then away from the Tracker 16 may activate a running program on a smart phone. However, two immediate movements in sequence, thus towards, away, towards, and then away) without pausing may activate a different program on the Tracker 16. The gesture may be multiple continuous movements to thereby control distinct functions if the Tracker 16 is capable of controlling more than one type of function. For example, the smart phone with a camera and a running program.

Alternatively, another method of avoiding accidental triggering of the Tracker 16 may be to use a timing system. For example, the user may need to move the Activator 10 to within a certain distance of the Tracker 16 for a predetermine period of time or dwell time. A dwell time may eliminate an accidental brush-by of the Activator 10 to cause triggering of the Tracker 16.

It was indicated earlier that all of the embodiments may need to provide feedback to the user. For example, it may be useful to know if the Tracker 16 has been activated or deactivated. The Tracker may use an audio signal, a visual signal, a haptic signal such as vibration, or a combination of these different types of signals to the user. Furthermore, the different signals can indicate different types of actions. One visual flash of light, one beep or a single vibration may be used to indicate activation of the Tracker 16 to the user. Similarly, two visual flashes of light, two beeps or two vibrations may be used to indicate deactivation of the Tracker 16.

Alternatively, different colors of light may be used, or different types of sounds or different haptic signals can be used. It should be understood that any combination of visual, auditory or haptic signals may be used in any convenient combination, and no particular example herein should be considered as limiting of the invention.

The following is an example of how the first embodiment shown in FIG. 1 might be used with the present invention. The user may place the helmet 22 on his/her head. The user then places the glove 12 on a hand. The user brings the Activator 10 in the glove 12 to within a predetermined distance of the Tracker 16 located on the helmet 22. The user may have to leave the Activator 10 within three inches of the Tracker 16 for a predetermined length of time. The user may then hear an audible beep from the Activator 10 or the Tracker 16 and/or feel a vibration from the Activator 10 as an indication that the Tracker 16 has toggled on or off. The nature of the indication signal may tell the user that the Tracker 16 toggled on or off.

Another example of the first embodiment may be a glove 12 and a smart phone. The Activator 10 in the glove 12 may be used to answer an incoming telephone call on the smart phone, and to hang up the smart phone after the call is complete.

In an alternative embodiment, the Activator 10 might be used to control different functions of a multi-function device such as a smart phone. For example, the Activator 10 might be capable of answering a telephone call, activating and deactivating a GPS tracking running program, activating and deactivating another fitness tracking function such as monitoring a heart rate, etc. This list of functions that may be controlled on a multi-function device such as a smart phone may be selectable so that the Activator 10 may function with all of the programs, but only one at a time. Furthermore, this list should not be considered to be limited to the examples given, but may be used for any program that can be activated and deactivated on a smart phone.

This is an example of use of the first embodiment and should not be considered as limiting of any modifications to the method described, including modifications to the non-contact gesture, the distance between the Activator 10 and the Tracker 16, the length of time that the Activator and the Tracker may need to be near to each other, or the indicator signal that tells the user that a toggling event has occurred.

The first embodiment of the invention may be limited to the Activator 10 communicating directly with the Tracker 16 in order to activate and deactivate the system. In another embodiment of the invention, the Activator 10 may not communicate directly to the Tracker 16.

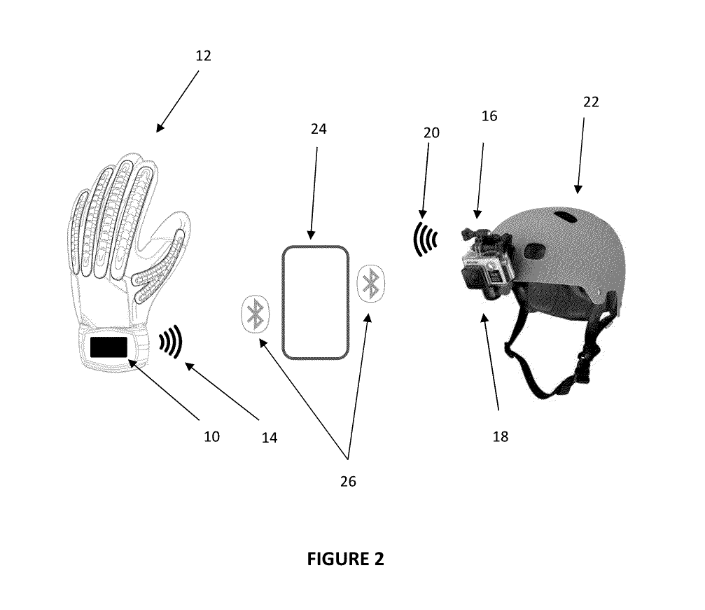

FIG. 2 is an illustration of a second embodiment of the invention. In this second embodiment, there is an intermediate or host device 24 that communicates with both the Activator 10 and the Tracker 16. The host device 24 may be referred to as a Tracker Pod or tPod. In this embodiment, the Activator 10 and the Tracker 16 do not communicate directly. There may be different reasons for this limitation. For example, there may be an application that is running on the host device 24 that may be controlling a function or recording data generated by the Tracker 16.

In this second embodiment, the host device 24 may communicate with the Activator 10 and the Tracker 16 using the same or different communication technology. FIG. 2 shows that the host device 24 is communicating using BlueTooth™ technology. However, the second embodiment should not be considered to be limited to this communication technology. Any communication technology that is available may be used for communication.

It may be useful to provide some examples of Activator 10 and Tracker 16 systems that may take advantage of the embodiments described herein. Some examples of the Activator 10 and Tracker 16 system may include selecting the Activator from the group of Activators including but not limited to a wrist device such as a watch or bracelet, a finger device such as a ring, a neck device or necklace, an arm band, a headband, and a belt.

Some examples of the Tracker 16 may include selecting the Tracker from the group of Trackers including but not limited to a smart phone, a satellite phone, a video recorder, a digital camera, a fitness tracking device, a GPS device and any electronic appliance that can be turned on or off, or paused in a function. The electronic appliance may be a portable device or a stationary device.

Some examples of the host device 24 may include selecting the host device from the group of host devices including but not limited to a smart phone or a dedicated host device.

It should be understood that the embodiments of the invention may be particularly useful in situations where a user is wearing gloves that are difficult or should not be removed, such as in a surgical environment or in a physical dangerous environment.

Another aspect of the Tracker 16 may be an ability to use low power signal pulses to recognize and to activate communication with the Activator 10.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for controlling a device using a non-contact gesture, said method comprising the steps of:
providing a tracking device that records or monitors data, the tracking device including a means for activating and deactivating the tracking device;
providing a signaling device for transmitting a signal to the tracking device, wherein the signal may deactivate the tracking device or activate the tracking device by toggling the means for activating and deactivating the tracking device; and
performing a non-contact gesture by bringing the signaling device to within a predetermined distance of the tracking device to cause the tracking device to perform a toggling event from a current state to a different state.

2. The method as defined in claim 1 wherein the method further comprises the step of selecting the current state and the different state from the group of states of the tracking device comprised of activating the tracking device, deactivating the tracking device, answering a telephone call, terminating a telephone call, starting a function on a smart phone, stopping a function on a smart phone, starting a video recording, stopping a video recording, taking a picture, starting a health tracking function, stopping a health tracking function, starting a GPS device, stopping a GPS device, pausing, and turning on or off an appliance.

3. The method as defined in claim 1 wherein the method further comprises the step of modifying the non-contact gesture to include a minimum time that the signaling device must be within the predetermined distance of the tracking device.

4. The method as defined in claim 1 wherein the method further comprises the step of providing an indicator that the toggling event has occurred.

5. The method as defined in claim 4 wherein the method further comprises the step of selecting the indicator from the group of indicators comprised of visual indicators, audible indicators and haptic indicators.

6. The method as defined in claim 1 wherein the method further comprises the step of selecting the means of communicating between the signaling device and the tracking device from the group of communication technologies comprised of near field communication (NFC) technology, Bluetooth™ technology, WiFi, cell phone wireless communication, any other radio frequency technology that enables a signal to be transmitted from the signaling device to the tracking device, and capacitive proximity sensing.

7. The method as defined in claim 1 wherein the method further comprises the step of selecting tracking device from the group of tracking devices comprised of a smart phone, a satellite phone, a video recorder, a digital camera, a fitness tracking device, a GPS device, a health monitoring device, and a stationary or portable electronic appliance.

8. A system for controlling a device using a non-contact gesture, said system comprised of:
a tracking device that records or monitors data, the tracking device including toggling means for activating and deactivating the tracking device;
a signaling device for transmitting a signal to the tracking device, wherein the signal may deactivate the tracking device or activate the tracking device by toggling the means for activating and deactivating the tracking device.

9. A method for controlling a device using a non-contact gesture, said method comprising the steps of:
providing a tracking device that records or monitors data, the tracking device including a means for activating and deactivating the tracking device;
providing a signaling device for transmitting a signal;
a host device for communicating with the tracking device and the signaling device, wherein the signaling device transmits a first signal that is received by the host device, and wherein the host transmits a second signal to the tracking device in response to the receiving the first signal from the signaling device; and
performing a non-contact gesture by bringing the signaling device to within a predetermined distance of the host device to cause the tracking device to perform a toggling event from a current state to a different state.
